(19) United States
(12) Patent Application Publication
(10) Pub. No.: US 2024/0407469 A1
(43) Pub. Date: Dec. 12, 2024

(54) HOUSING FOR AN AEROSOL PROVISION DEVICE

(71) Applicant: NICOVENTURES TRADING LIMITED, London (GB)

(72) Inventors: Sam LAI, London (GB); Chin Ting HUANG, Taipei City (TW); Hsi Kai HUNG, Taipei City (TW); Mardin HSIEH, Taipei City (TW); Blue LIU, Taipei City (TW); Kyo KO, Taipei City (TW)

(21) Appl. No.: 18/697,082

(22) PCT Filed: Sep. 29, 2022
(86) PCT No.: PCT/GB2022/052465

§ 371 Date: Mar. 29, 2024

(30) Foreign Application Priority Data
Sep. 30, 2021 (GB) 2114035.5

(51) Int. Cl. A24F 40/65; A24F 40/40

(52) U.S. Cl. CPC A24F 40/65; A24F 40/40

(57) ABSTRACT

A housing for an aerosol provision device is described comprising: a circuit board mounted within the housing; a radiating conductor element at least partially enclosing the circuit board; and an electrical connection between a first connection point on an inside of the radiating conductor element and an antenna signal output of the circuit board for providing an antenna signal for transmission such that, in use, the housing operates as an antenna.

### TECHNICAL FIELD

The present specification relates to a housing; in particular to a housing for an aerosol provision device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol provision device may be provided with a means for communication, for example for communication with a mobile communication device of a user of the device. There remains a need for further developments in this field.

### SUMMARY

In a first aspect, this specification describes a housing (e.g. a metal housing) for an aerosol provision device (e.g. a housing for an electronic smoking article). The housing comprises: a circuit board mounted within the housing; a radiating conductor element at least partially enclosing the circuit board; and an electrical connection between a first connection point on an inside of the radiating conductor element and an antenna signal output of the circuit board for providing an antenna signal for transmission such that, in use, the housing operates as an antenna. The electrical connection may comprise a contact spring.

In use, the housing may operate as a monopole antenna. In some alternative embodiments, the housing may operate, in use, as a dipole antenna.

The housing may further comprise a slot provided in the radiating conducting element. The slot may be in the vicinity of the first connection point. The slot may be sized to meet (or seek to meet) a desired antenna efficiency.

Some example embodiments further comprise an antenna matching circuit (e.g. an adjustable antenna matching circuit). The antenna matching circuit may be configured to adjust an operating frequency of the antenna. The antenna matching circuit may comprise an inductor and a capacitor (at least one of which may be adjustable).

The radiating conductor element may extend from a first surface to a second surface. Alternatively, or in addition, the radiating conductor element may have a substantially elliptical cross-section.

In some example embodiments, the housing further comprises a communication module. The communication module may be for communicating with a remote device, such as a mobile phone. The remote device may, for example, include a user interface (or an application providing a user interface). The communication module may be a Bluetooth module, a Wi-Fi module or some similar module. The communication module may be provided as part of the circuit board.

In a second aspect, this specification describes an aerosol provision device (e.g. a non-combustible aerosol provision device) comprising a housing including any of the features of the first aspect set out above.

In a third aspect, this specification describes an electronic smoking article comprising an aerosol provision device of the second aspect.

In a fourth aspect, this specification describes a method comprising using an aerosol provision device in accordance with the second aspect or an electronic smoking article in accordance with the third aspect for communications with a mobile communication device.

In a fifth aspect, this specification describes a method comprising: inserting a circuit board into a housing for an aerosol provision device such that an electrical connection of the circuit board provides an electrical connection between a first connection point on an inside of a radiating conductor element of the housing and an antenna signal output of the circuit board for providing an antenna signal for transmission (e.g. a Bluetooth signal or a WiFi signal) such that, in use, the housing operates as an antenna, wherein the radiating conductor element at least partially encloses the circuit board. The antenna signal may, for example, be used for locating the aerosol provision device. Once inserted, the circuit board may be fully enclosed by the housing.

The method may comprise matching an impedance between the antenna signal output and the housing. The method may further comprise adjusting the impedance matching.

The method may comprise generating the antenna signal output for transmission.

The method may comprise using the antenna signal for communications with a mobile communication device.

In a sixth aspect, this specification describes a kit of parts comprising an article (e.g. a removable article comprising an aerosol generating material) for use in a non-combustible aerosol generating system, wherein the non-combustible aerosol generating system comprises a housing including any of the features of the first aspect described above or a device including any of the features of the second aspect described above.

### BRIEF DESCRIPTION OF THE DRAWINGS

Example embodiments will now be described, by way of example only, with reference to the following schematic drawings, in which:

FIG. 1 is a block diagram of a non-combustible aerosol provision device in accordance with an example embodiment;

FIG. 2 is a block diagram of a system in accordance with an example embodiment;

FIG. 3 is a block diagram of a housing in accordance with an example embodiment;

FIG. 4 is a block diagram of a housing in accordance with an example embodiment;

FIGS. 5 and 6 are flow charts showing algorithms in accordance with example embodiments;

FIG. 7 is a block diagram of an antenna arrangement in accordance an example embodiment;

FIGS. 8 and 9 are plots showing functionality in accordance with example embodiments;

FIG. 10 is flow chart showing an algorithm in accordance with an example embodiment;

FIG. 11 shows an example user interface in accordance with an example embodiment; and

FIG. 12 is a block diagram of a non-combustible aerosol provision device in accordance with an example embodiment.

### DETAILED DESCRIPTION

As used herein, the term “delivery system” is intended to encompass systems that deliver at least one substance to a user, and includes:
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
articles comprising aerosolisable material and configured to be used in one of these non-combustible aerosol provision systems.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user. In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine.

In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In one embodiment, the aerosol generating component is a heater capable of interacting with the aerosolisable material so as to release one or more volatiles from the aerosolisable material to form an aerosol.

In one embodiment, the aerosolisable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolisable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12. In one embodiment, the active substance is a legally permissible recreational drug.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavours, carriers, pH regulators, stabilizers, and/or antioxidants.

In one embodiment, the article for use with the non-combustible aerosol provision device may comprise aerosolisable material or an area for receiving aerosolisable material. In one embodiment, the article for use with the non-combustible aerosol provision device may comprise a mouthpiece. The area for receiving aerosolisable material may be a storage area for storing aerosolisable material. For example, the storage area may be a reservoir. In one embodiment, the area for receiving aerosolisable material may be separate from, or combined with, an aerosol generating area.

Aerosolisable material, which also may be referred to herein as aerosol generating material, is material that is capable of generating aerosol, for example when heated, irradiated or energized in any other way. Aerosolisable material may, for example, be in the form of a solid, liquid or gel which may or may not contain nicotine and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosolisable material may be present on a substrate. The substrate may, for example, be or comprise paper, card, paperboard, cardboard, reconstituted aerosolisable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material or a material heatable by electrical conduction.

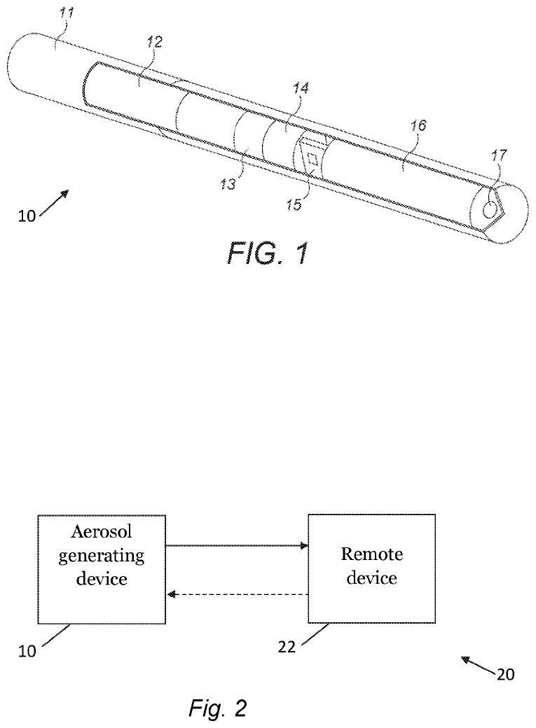

FIG. 1 is a block diagram of a non-combustible aerosol provision device, indicated generally by the reference numeral 10, in accordance with an example embodiment. The aerosol provision device 10 (such as an e-cigarette) comprises a mouthpiece 11, a cartridge or pod 12, an atomizer 13, a sensor 14, a control module 15, a battery 16 (e.g. a rechargeable lithium battery) and an LED 17 (or some other illumination device). The control module 15 may comprise a microprocessor.

In a use of the aerosol provision device 10, a user inhales from the mouthpiece 11. The cartridge or pod 12 may store a liquid solution (e.g. of glycerol, flavourings and nicotine).

The sensor 14 may be an air flow sensor configured to sense the air flow inhaled by a user and may provide an input to the control module 15. Functions of the control module 15 may include controlling the atomizer 13 and the LED 17. The device 10 may use the atomizer 13 to seek to simulate a smoke-like vapour flavour. The LED indicator light 17 may illuminate when used, simulating the fire light during smoking.

The control module 15 may include a communications means, such as a Bluetooth chip or WiFi chip. The communication means may be integrated into a microprocessor of the control module 15. An antenna (discussed in detail below) enables the communications means to communicate with a remote device (such as a mobile phone, a mobile communication device, a laptop, a computer or some other device), to enable information (such as e-cigarette usage statistics, liquid level data etc.) to be provided to a user (e.g. using an application of the remote device).

As discussed in detail below, the antenna may be provided by a shell or housing (e.g. a shell, housing or sleeve of the aerosol provision device 10); said shell or housing may be a metal shell or housing. The antenna may, for example, be dipole or monopole antenna.

The aerosol provision device 10 may include a connector, such as a USB connector (not shown) that enables a connection to be made to a power source for charging a battery 16.

The aerosol provision device 10 is provided by way of example only; many variants and alternatives are possible.

FIG. 2 is a block diagram of a system, indicated generally by the reference numeral 20, in accordance with an example embodiment. The system 20 comprises the aerosol provision device 10 and a remote device 22 (i.e. remote from the aerosol provision device). The remote device 22 may, for example, be a mobile phone, a mobile communication device, a laptop, a computer or a similar device, and may be owned or used by a user of the aerosol provision device 10.

As indicated above (and discussed in further detail below), the aerosol provision device 10 has an output that transmits a signal (such as a Bluetooth signal or a WiFi signal). The transmitted signal can be detected by the remote device 22 such that the aerosol provision device 10 can communicate with the remote device 22. In some example embodiments, the remote device 22 is able to transmit to the aerosol provision device (as indicated by the dotted line in the system 20), but this is not essential to all embodiments.

The signal transmitted from the aerosol provision device 10 to the remote device 22 may be used to transmit information such as how many e-cigarettes a user puffs (e.g. in a defined period, such as per day) or the amount of remaining liquid. The skilled person will be aware of many other examples of data that may be transmitted from the aerosol provision device 10 to the remote device 22 (or, indeed, data that may be transmitted from the remote device 22 to the aerosol provision device 10).

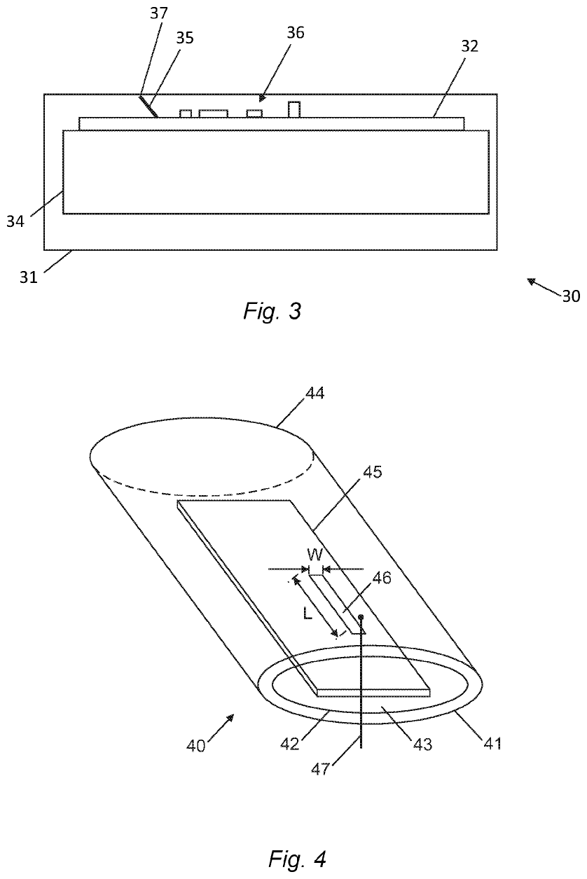

FIG. 3 is a block diagram of a housing, indicated generally by the reference numeral 30, in accordance with an example embodiment. The housing 30 comprises an outer sleeve 31, such as a metal sleeve (e.g. an aluminium sleeve), which sleeve may provide the exterior of at least some of the aerosol provision device 10 described above. Note that the housing 30 may be used with alternative aerosol provisioning or generating devices and electronic smoking articles.

As shown in FIG. 3, a printed circuit board 32 and a battery 34 are mounted within the housing 30. The electronic components of the control module 15 of the aerosol provision device 10 may be provided on the printed circuit board 32 (as indicated generally by the reference numeral 36). Other components may also be provided (such as the atomiser 13). Note that although the battery 34 is shown below the printed circuit board 32, this is just one example implementation. The printed circuit board and the battery may, for example, be provided side-by-side.

An electrical connection 35 is provided between a connection point 37 on an inside of the sleeve 31 and an antenna signal output for providing an antenna signal for transmission by the housing 30 (such that the housing can be used as an antenna). The electrical connection 35 may, for example, take the form of a contact spring.

FIG. 4 is a block diagram of a housing, indicated generally by the reference numeral 40, in accordance with an example embodiment. The housing 40 is an example implementation of the housing 30 described above. The housing 40 may be a sleeve (such as the sleeve 31 described above). The housing 40 may be an elliptical cylindrical shape and may be resilient such that there is some flexibility in the shape of the housing. The housing 40 may be shaped dependent on a shape of the aerosol provision device 10 (and may, for example, have a circular, rectangular, elliptical, diamond or any other shape). The housing 40 may be a metal housing.

The housing 40 comprises an elliptical radiating conductor shell having an outer side 41 and an inner side 42, a first elliptical element 43, a second elliptical element 44, a circuit board component 45, a slot 46, an antenna signal feed 47.

The slot 46 is provided to enable current inside the elliptical radiating conductor shell 41, 42 to flow to the outside of the elliptical radiating conductor shell, thereby improving the antenna efficiency (as discussed further below). For the aesthetic appearance of the product, non-conductive materials (such as a plastics material) can be attached or filled in the slot seam.

The circuit board component 45 can be equipped with a Bluetooth chip or a WiFi chip and an antenna output.

Although not shown in FIG. 4, the connection point of the housing referred to above with respect to FIG. 3 may be provided on the inner side 42 of the radiating conductor shell.

In the specific configuration shown in FIG. 4, the elements 43 and 44 have elliptical shapes; this is not essential to all example embodiments. The housing 40 may be shaped dependent on a shape of the aerosol provision device 10 (and may, for example, have a circular, rectangular, elliptical, diamond or any other shape).

A number of variants to the housing 40 are possible. For example, the first elliptical element 43 and/or the second elliptical element 44 may be provided with holes in the surface for some functions such as LED lights, buttons, air inlets, charging docks or the like.

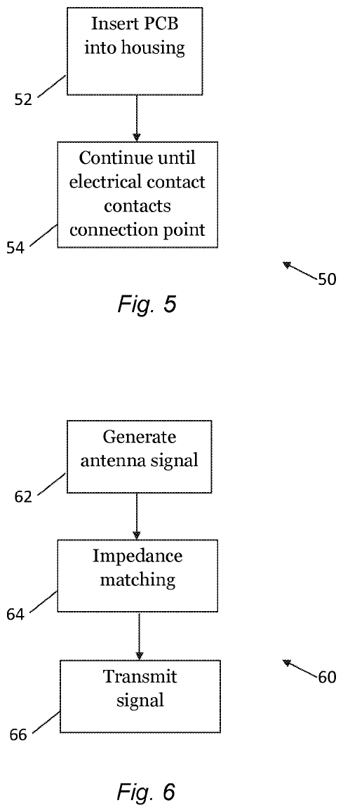

FIG. 5 is a flow chart showing an algorithm, indicated generally by the reference numeral 50, in accordance with an example embodiment.

The algorithm 50 starts at operation 52, where the printed circuit board 32 is inserted into the housing 30 (or the housing 40).

At operation 54, the insertion of the circuit board 32 continues until the electrical contact 35 (e.g. a contact spring) contacts the connection point 37 on the inside of the metal housing (e.g. on the inner side 42 of the radiating conductor shell). In this configuration, the electrical contact 35 provides an electrical connection between the connection point 37 and an antenna signal output for providing an antenna signal for transmission by the housing. It should be noted that the electrical contact 35 need not be a contact spring; for example, a pogo pin could be used.

When the algorithm 50 is complete, the printed circuit board 32 is fully enclosed within the housing 30 or 40.

FIG. 6 is a flow chart showing an algorithm, indicated generally by the reference numeral 60, in accordance with an example embodiment.

The algorithm 60 starts at operation 62, wherein an antenna signal is generated. The antenna signal may be generated by a control module.

At operation 64, impedance matching is provided between the antenna signal generating circuit and the transmitting antenna (e.g. the housing 30 or 40). The impedance matching is implemented by an antenna matching circuit 74 discussed further below. The antenna matching circuit may be used to control an operating frequency of the antenna and may comprise a capacitive element and an inductance element at least one of which may be adjustable to change the antenna operating frequency.

At operation 66, the signal is transmitted, using the metal housing as the antenna. The transmission may take the form of a Bluetooth signal or a WiFi signal.

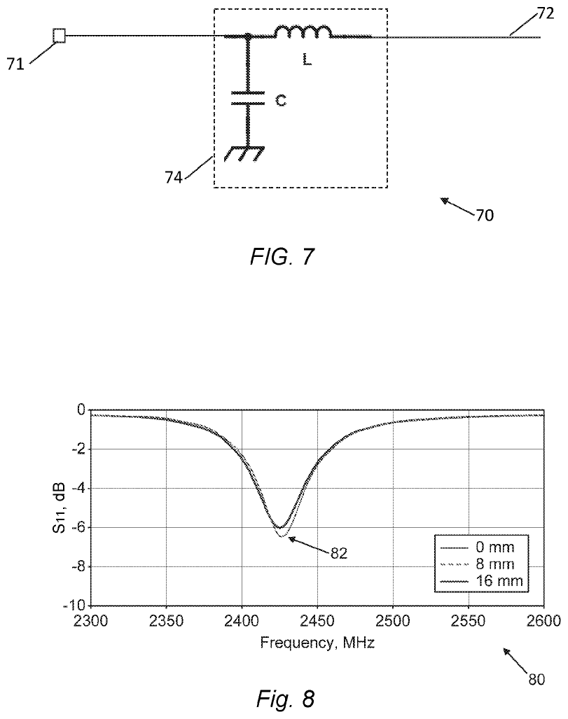

FIG. 7 is a block diagram of an antenna arrangement, indicated generally by the reference numeral 70, in accordance with an example embodiment. The antenna arrangement may be a monopole antenna; other antenna arrangements, such as a dipole antenna, could be used.

The antenna arrangement 70 includes a signal node 71 (such as the antenna signal feed 47 described above) a conductor 72 (such as the radiating conductor shell 41, 42 described above) and an antenna matching circuit 74 (which may be provided to adjust an operating frequency of the antenna).

As shown in FIG. 7, the antenna matching circuit 74 may comprise an inductance L and a capacitance C. The antenna matching circuit may be adjustable (e.g. if the inductance and/or the capacitance are adjustable). In one example implementation, the inductance is provided by a 3.3 mH inductor and the capacitance is provided by a 1.2 pF capacitor; clearly, alternative arrangements are possible.

The signal node 71 is connected to the conductor 72, for example using a spring such as the electrical connection (e.g. contact spring) 35 described above.

The signal node 71 may be used to transmit data from the aerosol provision device 10 to the remote device 22 described above. By way of example, data such as aerosol device usage data, battery level etc. may be transmitted. These data may be collected and used (e.g. displayed or stored) at the remove device 22. For example, the remote device 22 may be a mobile phone having an application that can be used to display information relating to the aerosol provision device 10.

As discussed above with reference to FIG. 2, an antenna signal may be sent from an aerosol provision device 10 (such as an electronic smoking article) to a remote device 22 (such as a mobile communication device). The remote device may use the data in many different ways.

FIG. 8 is a plot, indicated generally by the reference numeral 80, showing functionality in accordance with an example embodiment. The plot 80 shows data generated using a system having a slot element having a width 0.7 mm. Three different slot lengths were tested (omm, 8 mm and 16 mm respectively) and the results of using those slot lengths are plotted on FIG. 8.

FIG. 8 plots reflection loss (S₁₁) as measured using a network analyser for each of the three slot lengths. The plot 80 clearly shows a resonance mode frequency 82 at which the loss decreases substantially. The centre frequency of the resonance mode frequency 82 in each case is about 2425 MHz. Thus, the size (length) of the slot element 46 has little or no impact on the resonant mode frequency of the antenna.

The resonance mode frequency 82 covers the wireless Bluetooth communication frequency and the WiFi 2.4 G communication frequency. Accordingly, the metal housings 30, 40 may use the resonance mode frequency 62 for Bluetooth or WiFi transmissions.

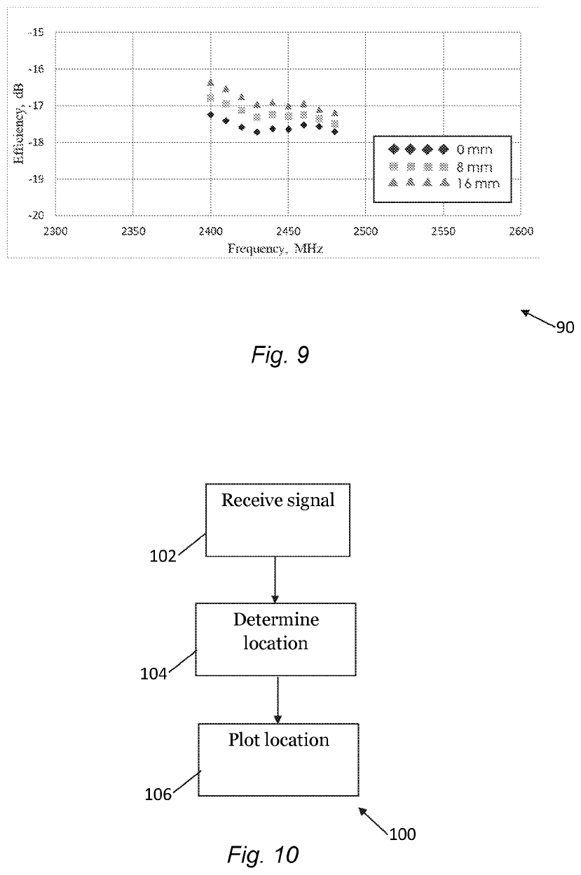

FIG. 9 is a plot, indicated generally by the reference numeral 90, showing functionality in accordance with an example embodiment. The plot 90 shows an efficiency diagram of the resonance mode antenna. The efficiency for three different slot lengths (0 mm, 8 mm and 16 mm) are plotted, showing that slot length has a measurable impact on reflection loss.

From the experimental results, it can be seen that the size of the slot element 46 has an impact on antenna efficiency. As the slot element 46 becomes longer, the antenna efficiency increases. The larger the size of the slot element is, the more current will be distributed outside the elliptical shell radiating conductor element, which helps to improve the antenna transmit and receive signals.

Bluetooth transmissions (at a frequency of about 2425 MHz) have a wavelength of about 12.5 cm. As discussed above, the antenna may be a monopole antenna. An ideal monopole antenna implemented by the metal housing 30, 40 may have a housing length of half the wavelength (about 6.25 cm), which is close to the dimensions of many suitable housings. A dipole antenna implemented by the metal housing 30, 40 may have an ideal housing length that is similar to or equal to the transmission wavelength (about 12.5 cm).

FIG. 10 is a flow chart showing an algorithm, indicated generally by the reference numeral 100, in accordance with an example embodiment. The algorithm 100 shows one example use of data that may be obtained by the remote device 22 from the aerosol provision device 10.

The algorithm 100 starts at operation 102, where a signal is received at the remote device 22 or some other mobile communication device from the aerosol provision device 10, an electronic smoking article or some similar device.

At operation 104, the location of said aerosol provision device, electronic smoking article or similar device is determined based on the received communications. The location determination may take the form of determining the location of the transmission relative to the location of the reception.

At optional operation 106, the location determined in operation 104 may be plotted, for example on a display of the remote device or mobile communication device.

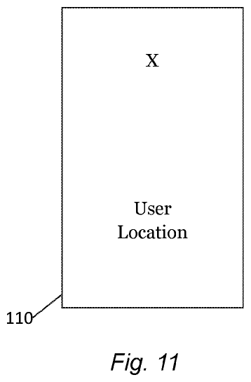

FIG. 11 shows an example user interface, indicated generally by the reference numeral 110, in accordance with an example embodiment. The user interface 120 may be output by the remote device 22 or by some other mobile communication device.

The user interface shows a user location (e.g. a location of the remote device 22) together with an indicator of the position of the aerosol provision device 10 (marked with an “X” in the user interface 110).

Of course, the user interface 110 is provided by way of example only; many alternative display configuration could be provided, including displaying other forms of data.

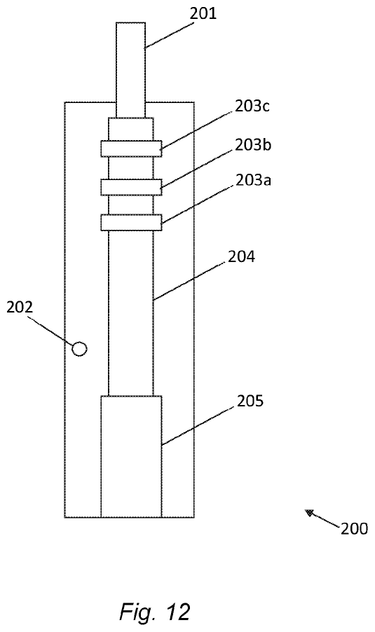

As discussed above, the aerosol provision device 10 is described by way of example only; many variants and alternatives are possible. By way of example, FIG. 12 is a block diagram of a non-combustible aerosol provision device, indicated generally by the reference numeral 200, in accordance with an example embodiment. The aerosol provision device 200 is an example implementation of the aerosol provision device 10 described above.

FIG. 12 shows the aerosol provision device 200 without an outer cover. The aerosol provision device 200 may comprise a replaceable article 201 that may be inserted in the aerosol provision device 200 to enable heating of the article 201. The aerosol provision device 100 further comprises an activation switch 202 that may be used for switching on or switching off the aerosol provision device 200 and a plurality of heating elements 203a, 203b and 203c, and one or more air tube extenders 204 and 205. The one or more air tube extenders 204 and 205 may be optional.

The heating elements 203a, 203b and 203c may be heaters that directly heat the article 10) 201. Alternatively, the heating elements 203a, 203b and 203c may be inductive heating elements that are configured to interact with a susceptor comprised within the article 201 (or provided elsewhere). The use of three heating elements 203a, 203b and 203c is not essential to all example embodiments. Thus, the aerosol provision device 100 may comprise one or more heating elements.

A susceptor may be provided as part of the article 201. In an example embodiment, when the article 201 is inserted in aerosol provision device, the aerosol provision device 200 may be turned on due to the insertion of the article 201. When the aerosol provision device 100 is turned on, the (inductive) heating elements 203 (e.g. inductive 20) heating elements) may cause the article 201 to be heated (e.g. inductively heated) through the susceptor. In an alternative embodiment, the susceptor may be provided as part of the aerosol provision device 200 (e.g. as part of a holder for receiving the article 201).

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A housing for an aerosol provision device, the housing comprising:
a circuit board mounted within the housing;
a radiating conductor element at least partially enclosing the circuit board; and
an electrical connection between a first connection point on an inside of the radiating conductor element and an antenna signal output of the circuit board for providing an antenna signal for transmission such that, in use, the housing operates as an antenna.

2. The housing as claimed in claim 1, wherein, in use, the housing operates as a monopole antenna.

3. The housing as claimed in claim 1, further comprising a slot provided in the radiating conducting element.

4. The housing as claimed in claim 3, wherein the slot is in the vicinity of the first connection point.

5. The housing as claimed in claim 3, wherein the slot is sized to meet a desired antenna efficiency.

6. The housing as claimed in claim 1, wherein the electrical connection comprises a contact spring.

7. The housing as claimed in claim 1, further comprising an antenna matching circuit.

8. The housing as claimed in claim 7, wherein the antenna matching circuit is adjustable.

9. The housing as claimed in claim 7, wherein the antenna matching circuit is configured to adjust an operating frequency of the antenna.

10. The housing as claimed in claim 7, wherein the antenna matching circuit comprising an inductor and a capacitor.

11. The housing as claimed in claim 1, wherein the radiating conductor element extends from a first surface to a second surface.

12. The housing as claimed in claim 1, wherein the radiating conductor element has a substantially elliptical cross-section.

13. The housing as claimed in claim 1, further comprising a communication module.

14. The housing as claimed in claim 13, wherein the communication module is for communicating with a remote device.

15. The housing as claimed in claim 13, wherein the communication module is a Bluetooth module or a Wi-Fi module.

16. The housing as claimed in claim 13, wherein the communication module is provided as part of the circuit board.

17. The housing as claimed in claim 1, wherein the housing is a metal housing.

18. The housing as claimed in claim 1, wherein the housing is a housing for an electronic smoking article.

19. An aerosol provision device comprising a housing as claimed in claim 1.

20. An electronic smoking article comprising an aerosol provision device as claimed in claim 19.

21. (canceled)

22. A method comprising:
inserting a circuit board into a housing for an aerosol provision device such that an electrical connection of the circuit board provides an electrical connection between a first connection point on an inside of a radiating conductor element of the housing and an antenna signal output of the circuit board for providing an antenna signal for transmission such that, in use, the housing operates as an antenna, wherein the radiating conductor element at least partially encloses the circuit board.

23. The method as claimed in claim 22, further comprising matching an impedance between the antenna signal output and the housing.

24. The method as claimed in claim 23, further comprising adjusting the impedance matching.

25. The method as claimed in claim 22, further comprising generating the antenna signal output for transmission.

26. The method as claimed in claim 22, wherein the antenna signal for transmission is a Bluetooth signal or a WiFi signal.

27. The method as claimed in claim 22, further comprising using the antenna signal for communications with a mobile communication device.

28. The method as claimed in claim 22, wherein the antenna signal is used for locating the aerosol provision device.
